(19) United States
(12) Patent Application Publication
(10) Pub. No.: US 2014/0006275 A1
(43) Pub. Date: Jan. 2, 2014

(54) ELECTRONIC IDENTIFICATION AND NOTIFICATION OF BANKING RECORD DISCREPANCIES

(71) Applicants: Carrie Anne Hanson, Charlotte, NC (US); Susan Smith Thomas, Gastonia, NC (US); David A. Grigg, Rock Hill, SC (US); Peter John Bertanzetti, Charlotte, NC (US); Matthew A. Calman, Charlotte, NC (US)

(72) Inventors: Carrie Anne Hanson, Charlotte, NC (US); Susan Smith Thomas, Gastonia, NC (US); David A. Grigg, Rock Hill, SC (US); Peter John Bertanzetti, Charlotte, NC (US); Matthew A. Calman, Charlotte, NC (US)

(73) Assignee: Bank of America Corporation, Charlotte, NC (US)

(21) Appl. No.: 13/536,821

(22) Filed: Jun. 28, 2012

(51) Int. Cl. G06Q 40/00; G06Q 20/36

(52) U.S. Cl. 705/41

(57) ABSTRACT

In general terms, embodiments of the present invention relate to apparatuses, methods, and computer program products for electronic identification and notification of banking record discrepancies associated with the use of mobile wallet functionality. For example, in some embodiments, an apparatus is provided that comprises a communication device, and a processing device communicable coupled to the communication device, wherein the processing device is configured to (a) receive mobile wallet information from a mobile computing device of the user, wherein the mobile computing device features mobile wallet functionality; (b) compare the mobile wallet information to bank records of the user; (c) determine, based at least partially on the mobile wallet information, whether there is a discrepancy associated with the user's account; and (e) present an indication of whether there is a discrepancy associated with the user's account.

### BACKGROUND

Consumers use various means for conducting transactions. Although consumers still use currency or checks to pay for goods and services, many alternative payment methods have become popular. For instance, consumers may now use a credit or debit card to pay for nearly any type of transaction.

Instead of using debit or credit cards, many mobile phones and other mobile computing devices are equipped with hardware and/or software that allow the mobile computing device to act as an electronic “mobile wallet.” In other words, the user's mobile computing device is configured to securely store credit card information, debit card information, bank account information, transaction information and/or other information about the ways in which the owner of the mobile computing device would like to pay for goods and services. When used in conjunction with payment terminals that are capable of communicating with mobile computing devices over secure networks, such as near field networks, users can employ this mobile wallet functionality of their mobile computing devices to pay for transactions. For example, by tapping or otherwise touching an mobile wallet equipped mobile computing device to a near field communication payment terminal, the consumer can pay for goods and services using credit card or debit card information that is stored in the mobile wallet.

Furthermore, besides the use of currency, debit cards, credit cards, or mobile wallet technology, consumers may use other electronic means for paying for transactions, such as initiating payments via an online banking website, text messaging, or mobile banking application.

A current problem with the proliferation of different payment methods is that it is often very difficult for a consumer to keep track of which payments he made and the methods he used to make each payment. As a result, certain transactions may appear in a consumer's online banking records, mobile wallet records, or other banking records and a consumer might not remember how the payment was made or whether the consumer actually authorized the payment. Another problem with the proliferation of different payment methods is that the use of such methods often causes different information from each transaction to be stored in different locations, such as in a mobile computing device and financial institution records. Accordingly, there exists a need for an improved system for identifying discrepancies associated with a consumer's accounts and notifying the consumer about such discrepancies. Specifically, there exists a need for an improved system to identify discrepancies and notify a customer about such discrepancies, when such discrepancies are caused by the user of mobile wallet technology.

### BRIEF SUMMARY

Embodiments of the invention relate to apparatuses, methods, and computer program products that provide electronic identification and notification of banking record discrepancies.

In some embodiments, the apparatus comprises a communication device, and a processing device communicable coupled to the communication device, wherein the processing device is configured to (a) receive mobile wallet information from a mobile computing device of the user, wherein the mobile computing device features mobile wallet functionality; (b) compare the mobile wallet information to bank records of the user; (c) determine, based at least partially on the mobile wallet information, whether there is a discrepancy associated with the user's account; and (d) present an indication of whether there is a discrepancy associated with the user's account.

In some embodiments of the invention, the discrepancy associated with the user's account comprises a fraudulent transaction. In other embodiments of the invention, the discrepancy associated with the user's account is caused by the entity providing the mobile wallet functionality.

In some embodiments of the invention, the apparatus is further configured to compare the mobile wallet information to the bank records to determine whether the mobile wallet information and the bank records list the same number of transactions. In other embodiments of the invention, the apparatus is further configured to compare the mobile wallet information to the bank records to determine whether the mobile wallet information and the bank records list purchases having the same values. In yet some other embodiments of the invention, the apparatus is further configured to compare the mobile wallet information to the bank records to determine whether the mobile wallet information and the bank records list transactions with the same third parties.

In some embodiments of the invention, the indication comprises an indication that appears on the display of a mobile computing device of the user.

In some embodiments of the invention, the apparatus automatically receives mobile wallet information from the mobile computing device of the user. In other embodiments of the invention, the apparatus only receives mobile wallet information from the mobile computing device of the user upon the action of the user.

In some embodiments, a computer implemented method is provided for determining whether there is a discrepancy associated with a user's account, the computer implemented method comprising: (a) receiving mobile wallet information from a mobile computing device of the user, wherein the mobile computing device features mobile wallet functionality; (b) comparing the mobile wallet information to bank records of the user; (c) determining, based at least partially on the mobile wallet information, whether there is a discrepancy associated with the user's account; and (d) presenting an indication of whether there is a discrepancy associated with the user's account.

In some embodiments, a computer program product for determining discrepancies associated with a user's account is provided, the computer program product comprising a non-transitory computer-readable medium, wherein the non-transitory computer-readable medium comprises computer executable program code store therein, the computer executable program code comprising: (a) a first executable portion configured for receiving mobile wallet information from a mobile computing device of the user, wherein the mobile computing device features mobile wallet functionality; (b) a second executable portion configured for comparing the mobile wallet information to bank records of the user; (c) a third executable portion configured for determining, based at least partially on the mobile wallet information, whether there is a discrepancy associated with the user's account; and (d) a fourth executable portion configured for presenting an indication of whether there is a discrepancy associated with the user's account.

### BRIEF DESCRIPTION OF THE DRAWINGS

Having thus described embodiments of the invention in general terms, reference will now be made the accompanying drawings, wherein:

FIG. 1 is a flow diagram illustrating a general process flow for electronic identification and notification of banking record discrepancies, in accordance with an embodiment of the invention;

FIG. 2 is a flow diagram illustrating a more detailed process flow for electronic identification and notification of banking record discrepancies, in accordance with an embodiment of the invention;

FIG. 3 is a flow diagram illustrating a more detailed process flow for electronic identification and notification of banking record discrepancies, in accordance with an embodiment of the invention;

FIG. 4 is provides a block diagram illustrating an system and environment configured to perform electronic identification and notification of banking record discrepancies, in accordance with an embodiment of the invention;

FIG. 5 is a block diagram illustrating a user's personal computing device of FIG. 4, in accordance with an embodiment of the invention; and

FIG. 6 is a mixed block and flow diagram of a system configured to perform electronic identification and notification of banking record discrepancies, in accordance with an embodiment of the invention.

FIG. 7 is a mixed block and flow diagram of a system configured to perform electronic identification and notification of banking record discrepancies, in accordance with an embodiment of the invention.

FIG. 8 is a mixed block and flow diagram of a system configured to perform electronic identification and notification of banking record discrepancies, in accordance with an embodiment of the invention.

### DETAILED DESCRIPTION OF EMBODIMENTS OF THE INVENTION

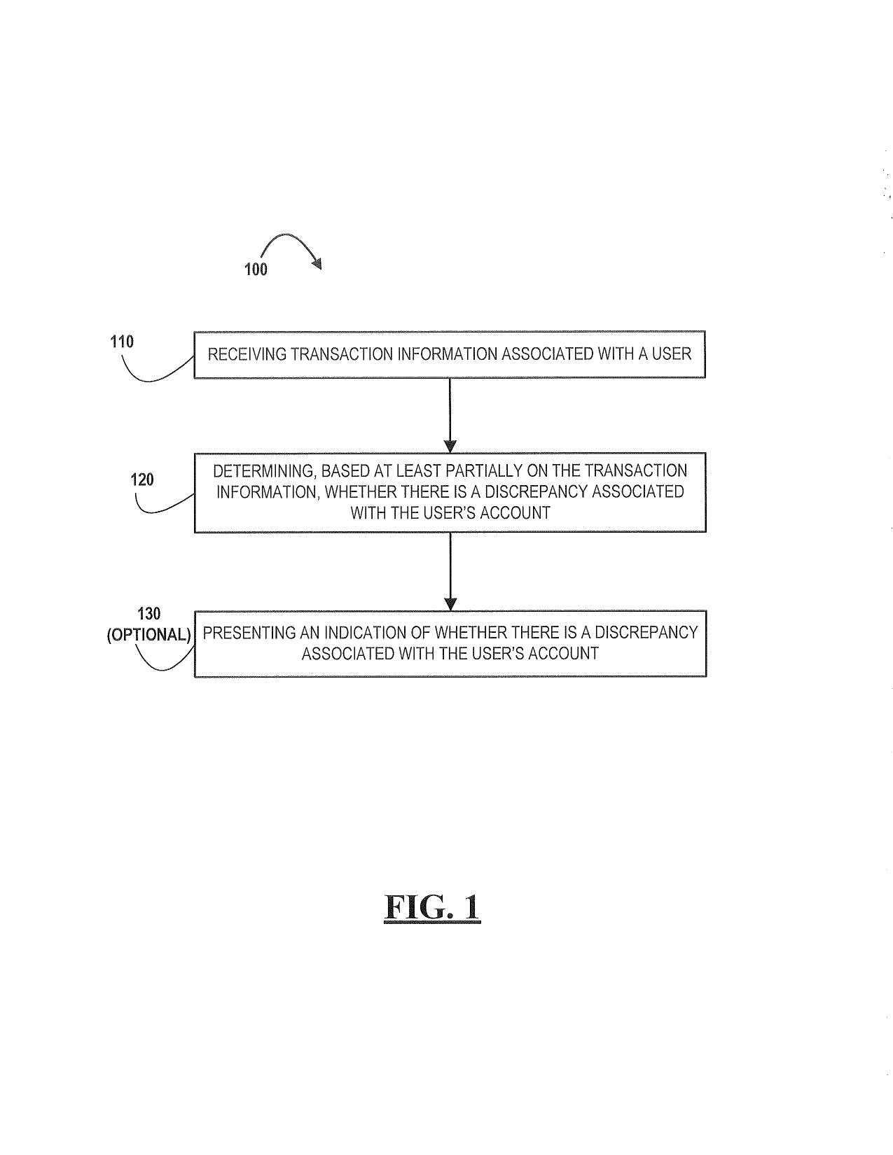

Referring now to FIG. 1, a general process flow 100 is provided for electronic identification and notification of banking record discrepancies. In some embodiments, the process flow 100 is performed by an apparatus (i.e., one or more apparatuses) having hardware and/or software configured to perform one or more portions of the process flow 100. In such embodiments, as represented by block 110, the apparatus is configured to receive transaction information associated with a user. As represented by block 120, the apparatus is also configured to determine, based at least partially on the transaction information, whether there is a discrepancy associated with the user's account. In addition, as represented in optional block 130, the apparatus is configured to present an indication of whether there is a discrepancy associated with the user's account.

The term “determine,” in some embodiments, is meant to have one or more of its ordinary meanings (i.e., its ordinary dictionary definition(s)), but in other embodiments, that term is meant to have one or more ordinary meanings of one or more of the following terms: decide, conclude, verify, ascertain, find, discover, learn, calculate, observe, read, and/or the like. Further, in some embodiments, the phrase “based at least partially on,” is meant to have one or more of its ordinary meanings, but in other embodiments, that phrase is meant to have one or more ordinary meanings of one or more of the following terms and/or phrases: as a result of, because, after, if, when, in response to, and/or the like. Lastly, the term “personal computing device” is meant to have one or more of its ordinary meaning, but in other embodiments, the phrase is meant to mean any one of the following: a desktop computer, a tablet computer, a laptop computer, a mobile computing device, mobile phone, a personal digital assistant, a gaming device, or any other device with similar functionality.

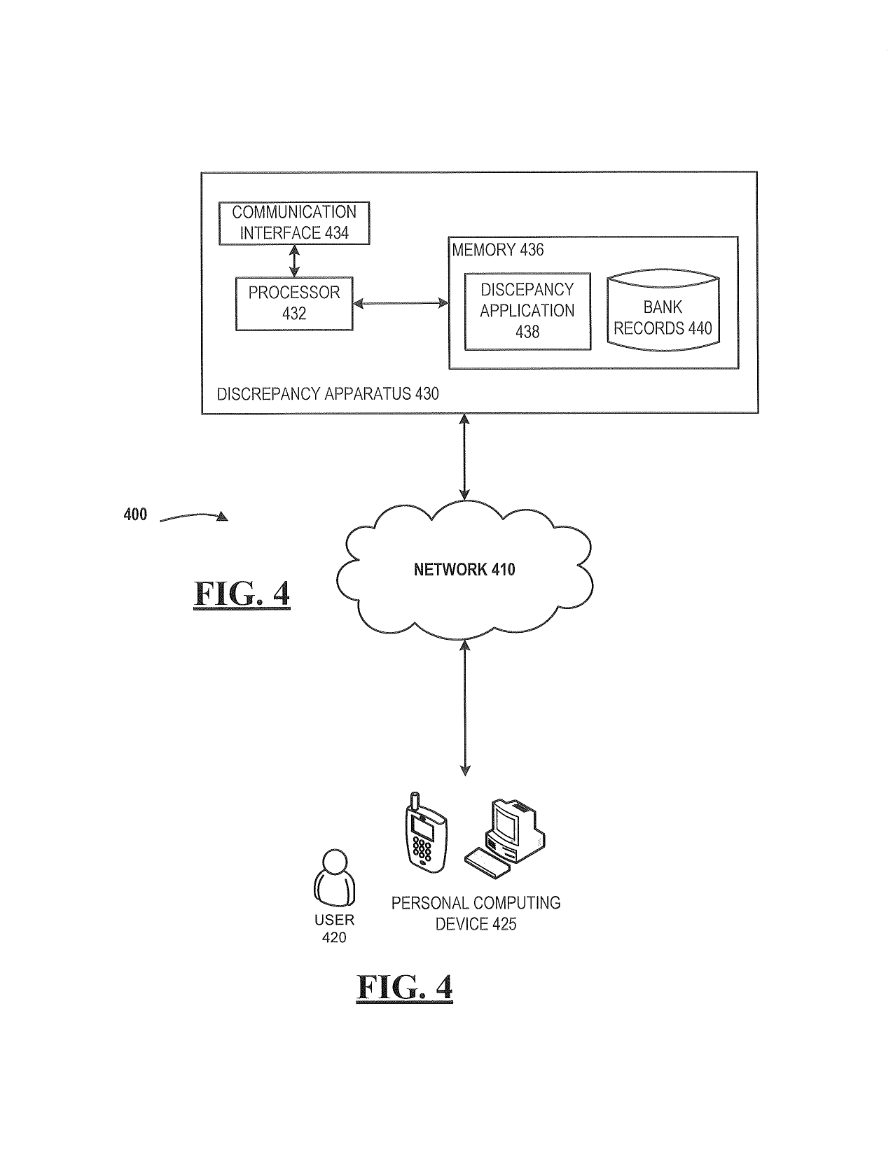

It will also be understood that the apparatus having the process flow 100 can include one or more separate and/or different apparatuses. For example, in some embodiments, a first apparatus (e.g., the discrepancy apparatus 430 described in connection with FIG. 4) is configured to perform the portions of the process flow 100 represented by blocks 110 and 120, and a second apparatus (e.g., the personal computing device 425) is configured to perform the portion of the process flow 100 represented by block 130. Alternatively, in other embodiments, a single apparatus (e.g., the discrepancy apparatus 430, the personal computing device 425, etc.) is configured to perform all of the portions of process flow 100 represented by blocks 110-130. In some embodiments, a single apparatus performs all of the portions of process flow 100 and has the combined functionality of discrepancy apparatus 430 and personal computing device 425.

Regarding block 110, the phrase “transaction” refers to any type of transaction, including but not limited to, a purchase of goods or services, a sale of goods or services, a transfer of funds, a receipt of funds, any type of loan or other debt and any other type of transaction that would be known to one of skill in the art.

The transaction may be a transaction with any person or type of entity. For instance, the transaction may be with a merchant, retailer, company or corporation. Alternatively, the transaction may be with an individual, whether that individual is acting in his/her personal or business capacity.

The transaction information associated with a user, or “transaction information” may be any amount and/or type of information that is associated with a transaction that was made by a user. The transaction information may include, but is not limited to, the name of individual or entity with whom the transaction is entered, the cost of the transaction, the date of the transaction, the time of the transaction, or the location of the transaction (e.g., city, state, town, zip code, address, area code, GPS coordinates, etc.).

The transaction information may comprise information that is stored in or associated with a user's mobile wallet. As used herein, the terms “mobile wallet”, or “mobile wallet functionality” describe an account that allows a user to make purchases using the functionality of a mobile computing device in connection with a merchant terminal (e.g., tapping a mobile computing device to a near-field communications (“NFC”) terminal, etc.). As used herein, the term “mobile wallet information” means any type of information associated with a user's mobile wallet.

In some embodiments, a user's mobile wallet is managed by a third party. In such embodiments, when the user makes a purchase from a merchant using the mobile wallet, the third party that manages the mobile wallet will act as the merchant of record and transmit information about the purchase to the user's financial institution. As one of skill in the art will appreciate, the third party that manages the mobile wallet account may appear as the merchant of record in the financial institution's records, while the user'

The transaction information may also comprise information that is associated with a user's bank records, including but not limited to information that is accessible via an online banking website or mobile banking application.

In some embodiments, the transaction information is stored on a mobile computing device of a user. As used herein, the term “mobile computing device” refers to any type of mobile computing device, such as a mobile phone, smartphone, personal digital assistant, etc. In other embodiments, the transaction information is stored on computer hardware that is maintained by the user's financial institution. In yet some other embodiments, the transaction information is stored on computer hardware that is maintained by a third party, such as a third party that is acting on behalf of the user's financial institution.

The apparatus having the process flow 100 receives the transaction information via a network. In some embodiments, the apparatus receives the transaction information via a wireless and/or contactless network. In some embodiments, the apparatus receives the transaction information via second-generation (2G) wireless communication protocols (e.g., IS-136 (time division multiple access (TDMA), GSM (global system for mobile communication), and/or IS-95 (code division multiple access (CDMA)), third-generation (3G) wireless communication protocols (e.g., Universal Mobile Telecommunications System (UMTS), CDMA2000, wideband CDMA (WCDMA) and/or time division-synchronous CDMA (TD-SCDMA)), fourth-generation (4G) wireless communication protocols, and/or the like. In some other embodiments, the apparatus having the process flow 100 is configured to receive the transaction information in accordance with non-cellular communication mechanisms, such as via a wireless local area network (WLAN), global area network (GAN), a wide-area network (WAN), the Internet, and/or other communication/data networks. In other embodiments, the apparatus having the process flow 100 receives the transaction information through a hardwired connection.

In some embodiments, the apparatus having process flow 100 receives the transaction information from a mobile computing device. In other embodiments, the apparatus having process flow 100 receives the transaction information from a computing system. In some of these embodiments, the computing system may be maintained by the user's financial institution or a third party acting on behalf of the financial institution.

Regarding block 120, the term “account” means any type of financial account, including but not limited to, a bank account, checking account, savings account, debit card account, credit card account, mobile wallet, gift card account, loyalty card account, store-specific account, etc. Additionally, the phrase “discrepancy associated with the user's account” (also referred to as a “discrepancy”) means any type of discrepancy, incomplete information, error or suspicious activity associated with the user's account. As one of skill in the art will appreciate, an authorized charge, payment, transaction or any other type of unauthorized or fraudulent activity may appear as a discrepancy with the user's account. For example, in some embodiments, a user may view his mobile wallet information and identify a transaction that he is not certain that he authorized. In such embodiments, the allegedly unauthorized transaction may be a discrepancy with the user's account. In other embodiments, the user may access his banking information (e.g., via an online banking website, via a mobile application, etc.) and identify a transaction that he is not certain that he authorized. In such embodiments, the allegedly unauthorized transaction may be a discrepancy associated with the user's account. As another example, a discrepancy with a user's account may occur when a user makes a payment using a mobile wallet. In some instances, the third party that manages the mobile wallet may report information to the user's financial institution that may differ from the mobile wallet information. Such differences may include, but are not limited to, listing a different merchant of record, listing a different number of transactions, and/or listing a different transaction amount. Thus, the discrepancy comprises the difference between the mobile wallet information and banking records associated with the user's account.

In some embodiments of the invention the apparatus having process flow 100 determines, based at least partially on the transaction information, whether there is a discrepancy associated with the user's account by comparing the transaction information to information associated with the user's account. If the transaction information does not match all or a portion of the information associated with the user's account, then there is a discrepancy associated with the user's account. If the transaction information does match all or a portion of the information associated with the user's account, then there is not a discrepancy associated with the user's account. As used herein, the term “match” is meant to have one or more of its ordinary meanings, but in other embodiments, that phrase is meant to have one or more ordinary meanings of one or more of the following terms and/or phrases: correlate with, correspond to, or relate to.

In some embodiments, if there is a partial match between the transaction information and the information associated with the user's account or if the apparatus having process flow 100 is unable to determine whether there is a match (due to incomplete information, etc.), the apparatus having process flow 100 may request additional information from the user or ask the user to confirm whether or not certain information associated with the user's account matches transaction information.

The information associated with the user's account may be any amount and/or type of information associated with the user's account, including but not limited to, bank records, mobile wallet information, the types transactions made with the account, the locations (e.g., store name, address, GPS coordinates, etc.) where transactions were made using the account, the amounts of transactions that were made with the account, the dates/times of transactions that were made with the account, the method of payment (e.g., credit card/debit card, mobile wallet, etc.). As one of skill in the art will appreciate, the information associated with the user's account may comprise any type of information associated with a user's account.

As an example, in relation to block 120, there is a discrepancy associated with a user's account if mobile wallet information includes more transactions then a user's bank records or if mobile wallet information contains a transaction with a value that does not match any of the transaction values of the user's bank's records. Such discrepancies may occur when a user uses a mobile wallet to make multiple transactions and the third party managing the mobile wallet reports all of those transactions to the user's financial institution as one aggregate transaction.

As yet another example, in relation to block 120, there is a discrepancy associated with a user's account if mobile wallet information includes a transaction with a merchant that differs from the merchants contained in the user's bank records. Such a discrepancy may occur when a user uses a mobile wallet to make a transaction at a merchant and the third party managing the mobile wallet lists itself as the merchant of record, instead of listing the name of the merchant with which the user conducted the transaction.

As yet another example, in relation to block 120, there is a discrepancy associated with a user's account if mobile wallet information indicates one transaction with a merchant and the user's bank records indicate 2 or more of the same transaction. As one of skill in the art will appreciate, this could happen if a certain transaction is posted more than once to the user's bank account. For instance, a user could accidentally tap their phone, which features mobile wallet functionality, against a NFC payment terminal twice, thus causing the merchant to erroneously process the transaction two times.

As yet another example, in relation to block 120, a discrepancy could also be associated with a user's account if the user mistakenly believes that a mobile wallet payment was not successful and subsequently pays for a transaction using a credit or debit card. In such instances, the mobile wallet payment may have actually been successful and the user makes a duplicate payment using his credit or debit card. In such instances, the user's bank records may show two payments (i.e., one with the mobile wallet, another with the debit/credit card), but the user's mobile wallet will only the single mobile wallet payment.

The apparatus using process flow 100 may use any method to determine whether there is a match between the transaction information and the information associated with the user's account. For example, the apparatus could use text comparison, pattern recognition or data comparison techniques to determine there is a match between the transaction information and the information associated with the user's account. In some embodiments, the apparatus having process flow 100 may only determine whether the transaction information matches the information associated with the user's account within a certain degree of confidence. In such embodiments, if the match is within a certain degree of confidence, then it will be considered an exact match. The apparatus using process flow 100 may use different methods to determine whether there is a match between the transaction information and the information associated with the user's account depending on what type of information is being compared. For instance, the apparatus may use text comparison techniques to compare the names of merchants of record, but alternatively, could use algorithms and other mathematical analysis to compare the values of transactions.

Regarding optional block 130 the phrase “an indication of whether there is a discrepancy associated with the user's account” means any type of notification that notifies the user that there is a discrepancy associated with the user's account. The apparatus having process flow 100 presents an indication of whether there is a discrepancy associated with the user's account by using any type of method known to those skilled in the art, including but not limited to, sending an email to the user, sending a SMS or MMS message to the user, initiating the mailing of postal mail to the user, displaying a notification on the display of the user's computing device (e.g., a pop-up box, etc.), causing the user's computing device to emit a sound and/or vibrate, shake, etc.

In some embodiments, the indication of whether there is a discrepancy associated with the user's account may comprise a notification of information that is used to resolve the discrepancy. For example, if the discrepancy relates to a difference in the name of a merchant of record, the indication of whether there is a discrepancy associated with the user's account could comprise the name of the correct merchant of record.

Additionally, although not depicted in FIG. 1, in some embodiments of the invention, if apparatus having process flow 100 determines that there is a discrepancy associated with the user's account, the apparatus may take additional steps to resolve the discrepancy. For instance, embodiments where the apparatus having process flow 100 is operated by a user's financial institution, the user's financial institution may take steps to resolve the discrepancy. If the discrepancy is likely caused because a third party is managing a user's mobile wallet, then the user's financial institution may request additional information from that third party. As an example, if the discrepancy is likely due to a third party aggregating numerous mobile wallet transactions into one single transaction, the financial institution may request information about the individual transactions to determine whether they match the financial institution's records. As another example, if the discrepancy is likely due to a difference in the name of the merchant of record, the financial institution may request information about the actual merchant with which the mobile wallet transaction was made (as opposed to the name of the third party managing the mobile wallet service) in order to reconcile the discrepancy.

In some embodiments of the invention, the apparatus having process flow 100 does not perform block 130. In such embodiments, the apparatus may correct any discrepancy associated with the user's account (as determined in block 120) without notifying the user.

In some embodiments, the apparatus having process flow 100 performs process flow 100 automatically. In some of such embodiments, it may perform process flow 100 automatically whenever the user enters into a new transaction. For example, if the user uses a mobile computing device to access his mobile wallet, the mobile computing device could automatically perform process flow 100 to determine whether there is a discrepancy between any of the information stored in a mobile wallet and online banking account. Alternatively, if a financial institution associated with a user identifies a new transaction, then a computing device associated with that financial institution could automatically perform process flow 100 to determine whether there is a discrepancy between the financial institution's records and the user's mobile wallet information. The automatic performance of process flow 100 could occur immediately after the transaction is finalized or any time after the transaction is finalized (e.g., 15 minutes, 1 hour, 1 day, 1 week, etc.) In some embodiments, the user could specify the time interval after which the apparatus having process flow 100 automatically performs process flow 100.

In embodiments where process flow 100 is performed automatically, the apparatus having process flow 100 may provide functionality to allow the user to input different conditions, preferences or filters for when he should and/or should not be presented with an indication of whether there is a discrepancy associated with the users account. For instance, the user could add a preference to never be notified if a discrepancy relates to a transaction at a certain retailer, a transaction occurring at a certain geographic location, or a transaction having less than a certain threshold dollar amount. As one of skill in the art will appreciate, these conditions, preferences or filters enable a user to block indications of an apparent discrepancy in situations where a user may know that all such transaction have been authorized. For instance, a user may provide a credit card to a family member that is linked to the user's account. If that family member makes purchases using that credit card, such purchases might be identified by the user's financial institution, but not appear in the user's mobile wallet application. In such situations, the user may not want to be notified of a discrepancy, provided that the credit card purchases occurred in the town where the family member lives, or were made a store where the family member frequents, or are less than a certain dollar amount, etc.

In some other embodiments, the apparatus having process flow 100 performs process flow 100 upon the action of the user. For example, the user may access transaction information via an online banking website, a mobile banking application or a mobile wallet application. The user may identify a transaction that he is not sure whether he authorized or not. In such an embodiment, the user may request (via the online banking website, mobile banking application or mobile wallet application) that the apparatus having process flow 100 perform process flow 100 determine whether there is a discrepancy associated with the user's account. This request could be made by disputing the payment that is associated with the transaction in question.

Further, in some embodiments, the user may initiate the process flow of FIG. 1 not to initiate a request to investigate an apparent discrepancy, but rather to obtain additional information about a mobile wallet transaction. For instance, where a third party manages a user's mobile wallet, the user may initiate the process flow of FIG. 1 to obtain the correct name of a merchant of record, where the user's mobile wallet only indicates the name of the third party managing the user's mobile wallet functionality. Initiating this process flow could be useful where a user needs to present proof of a purchase to the merchant, but the user's records display a different merchant of record (or any other information that differs from the merchant's own records). As yet another example, a user may identify a mobile wallet transaction having an unfamiliar merchant of record or a merchant of record located in another state. As one of skill in the art will appreciate, this may often happen when a user makes a transaction at a franchise or other retailer having multiple locations, and the merchant of record differs from the name under which the merchant does business (i.e., merchant of record is “Corporation X”, but the d/b/a name of the merchant is “Retailer Y”). In such an example, the user could initiate the process flow of FIG. 1 to obtain additional information about the d/b/a name of the merchant at which the user made a transaction. As one of skill in the art will appreciate, the user's financial institution's records may contain the d/b/a name of the merchant at which the user made a transaction or the financial institution may determine the d/b/a name based upon the merchant of record for the transaction.

Additionally, in some embodiments, the user's mobile device (or an application executed from the mobile device) could provide the user with functionality for adding additional information about a mobile wallet transaction. For instance, the user could edit a transaction record (e.g., add the name of the correct merchant of record, etc.), add supplemental information about a transaction record (e.g., notes about the transaction, etc.), or add any additional information that would make the transaction record more useful for the user.

As one of skill in the art will appreciate, a user could make such an action using any type of means and functionality. In some embodiments, the user performs such an action by interacting with the touchscreen of a computing device, such as a mobile phone or tablet computer. In such embodiments, the user may tap or otherwise physically indicate that he would like the apparatus having process flow 100 to perform such process flow. In other embodiments, the user uses a mouse, track pad or other type of user interface to make such an action. Alternatively, the user could make such an action by using voice commands, physical gestures or making a request via any type of communication channel.

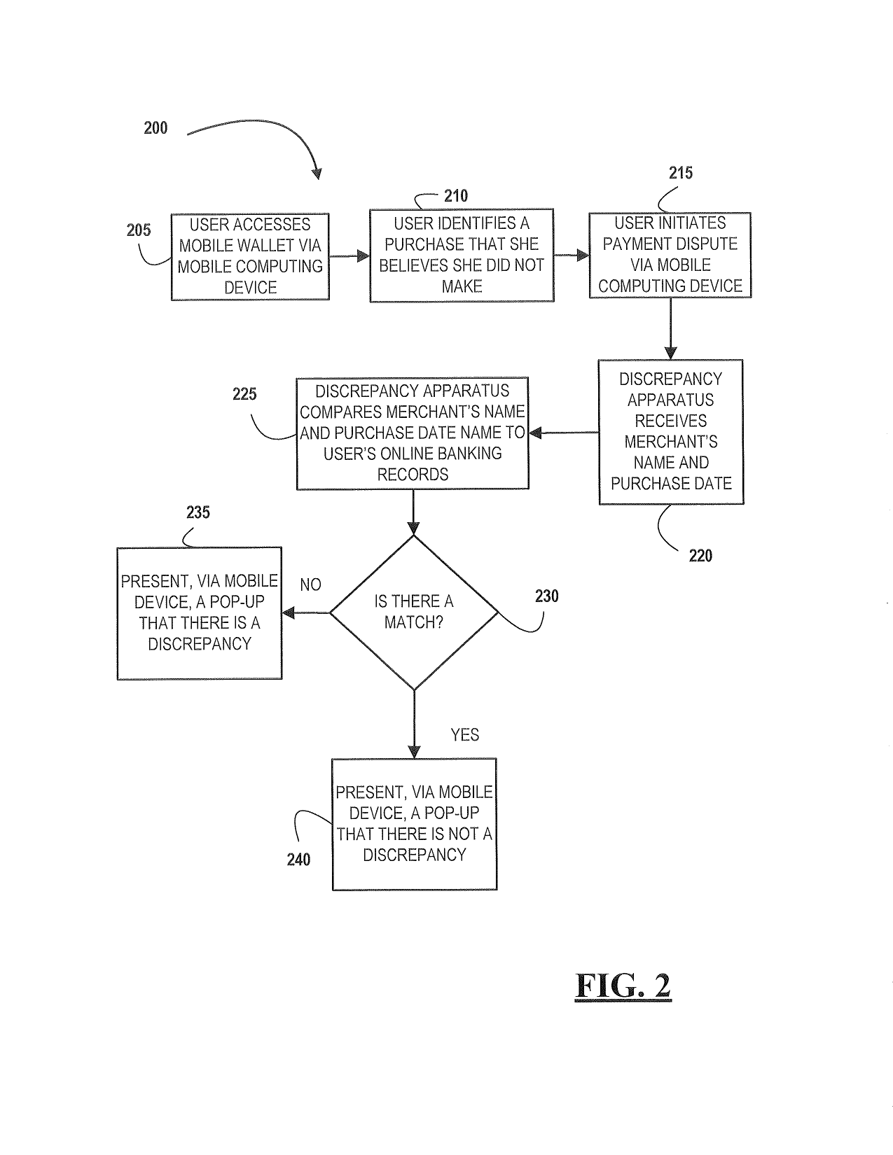

Referring now to FIG. 2, a more-detailed process flow 200 for electronic identification and notification of banking record discrepancies is provided, in accordance with an embodiment of the present invention. In some embodiments, one or more portions of the process flow 200 are performed by an apparatus having hardware and/or software configured to perform one or more portions of the process flow 200. In some of these embodiments, the apparatus configured to perform the process flow 100 is also configured to perform the process flow 200. As such, it will be understood that the process flow 200 illustrated in FIG. 2 represents an example embodiment of the process flow 100 described in connection with FIG. 1.

Referring to block 205, the user accesses her mobile wallet via her mobile computing device. Upon accessing the mobile wallet, the user may view all or any portion of the purchases that have been executed using the mobile wallet. At block 210, the user identifies a purchase that she believes she did not make. For example, at block 210, the user may identify a purchase in the amount of $200.00 at Grocery Store X that occurred on Jan. 10, 2012. The user may not remember making such a transaction and/or may believe that she did not make such a transaction. Accordingly, at block 215, the user initiates a payment dispute via her mobile computing device. Although not depicted in connection with FIG. 2, user's mobile wallet may also allow the user to provide additional information when initiating a dispute, such as user provided text or comments that could be used to help reconcile any dispute.

At block 220, the discrepancy apparatus (i.e., discrepancy apparatus 430) receives transaction information associated with the user. In the embodiment of the invention represented by block 220, the discrepancy apparatus receives the name of Grocery Store X and the date of the purchase, namely, Jan. 10, 2012. As block 225, the discrepancy apparatus compares the merchant's name and the date of the purchase to the user's online banking records. In this embodiment of the invention, the online banking records contain a list of all transactions that have been made with the bank account that is linked to the user's mobile wallet. The discrepancy apparatus searches the list of all transactions to see if it contains an entry for a transaction occurring at Grocery Store X at Jan. 10, 2012.

At block 230, the discrepancy apparatus determines whether there is a match between the name of the grocery store, Grocery Store X, the date of the purchase, Jan. 12, 2012, and the user's online banking records. At block 235, if the discrepancy apparatus determines that there is not a match between the name of the grocery store, Grocery Store X, the date of the purchase, Jan. 12, 2012, and the user's online banking records, then the discrepancy apparatus determines that there is a discrepancy associated with the user's account and the discrepancy apparatus presents, via the user's mobile computing device, a pop-up box indicating that there is a discrepancy associated with the user's account. This pop-up box is displayed on the display of the user's mobile computing device. In some embodiments of the invention, the discrepancy apparatus may also prompt the user's mobile computing device to play a noise, vibrate, or utilize any other functionality that would alert the user to the pop-up box.

The pop-up box that is displayed at block 235 may be in any size, shape, and format. Additionally, the pop-up box may use any combination of words or symbols to indicate that there is a discrepancy associated with the user's account. In some embodiments, the pop-up box will indicate the alleged payment that is causing the discrepancy (e.g., the Jan. 12, 2012 payment at Grocery Store X), and provide any other relevant information about the user's account (e.g., the status of the user's dispute request, etc.). Further, in some embodiments, the pop-up box may include hyperlinks to allow the user to contact the user's financial institution (via phone, email, etc.) and/or submit additional information about the discrepancy.

At block 240, if the discrepancy apparatus determines that there is a match between the name of the grocery store, Grocery Store X, the date of the purchase, Jan. 12, 2012, and the user's online banking records, then the discrepancy apparatus determines that there is not a discrepancy associated with the user's account. Thus, the discrepancy apparatus presents, via the user's mobile computing device, a pop-up box indicating that there is not a discrepancy associated with the user's account. This pop-up box is displayed on the display of the user's mobile computing device. In some embodiments of the invention, the discrepancy apparatus may also prompt the user's mobile computing device to play a noise, vibrate, or utilize any other functionality that would alert the user to the pop-up box.

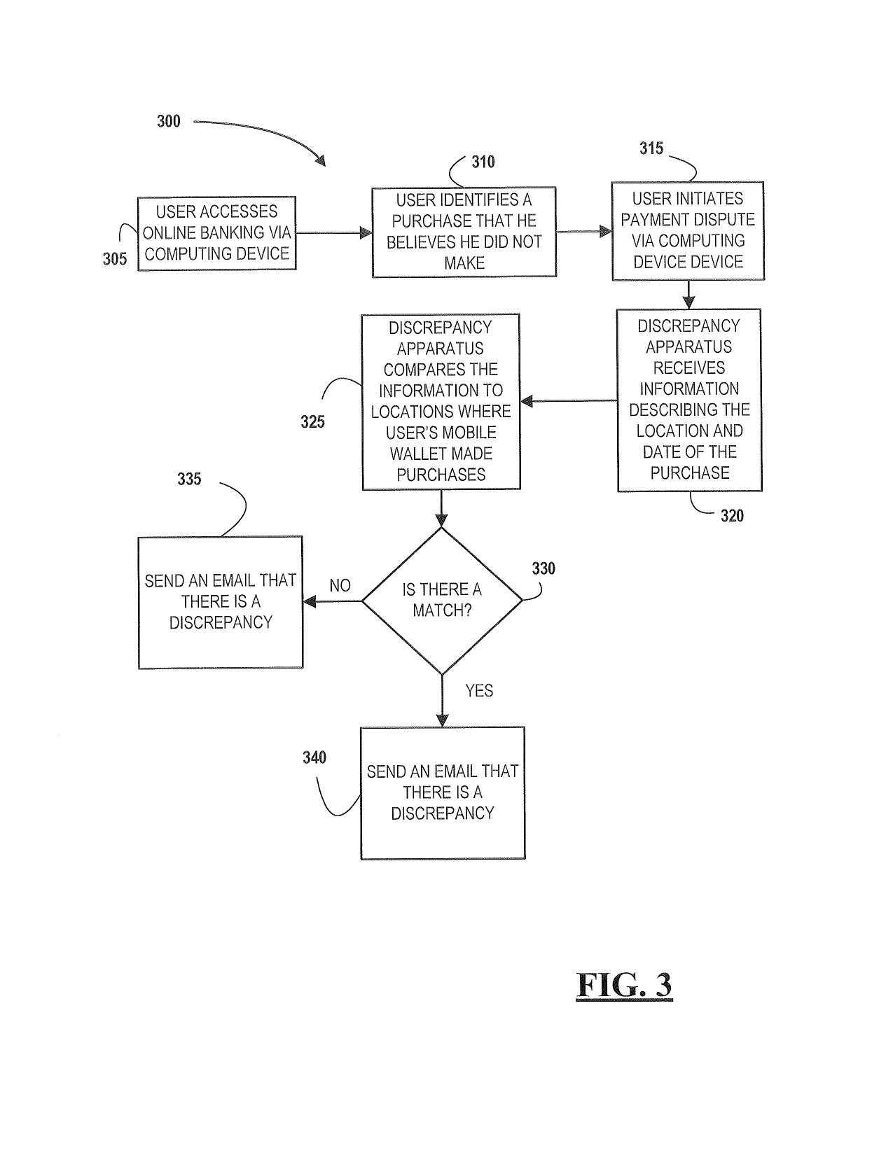

Referring now to FIG. 3, a more-detailed process flow 300 for electronic identification and notification of banking record discrepancies is provided, in accordance with an embodiment of the present invention. In some embodiments, one or more portions of the process flow 300 are performed by an apparatus having hardware and/or software configured to perform one or more portions of the process flow 300. In some of these embodiments, the apparatus configured to perform the process flow 100 is also configured to perform the process flow 300. As such, it will be understood that the process flow 300 illustrated in FIG. 3 represents an example embodiment of the process flow 100 described in connection with FIG. 1.

Referring to block 305, the user accesses his online banking account via his computing device, such as a laptop computer, desktop computer or tablet computer. In the embodiment of the invention described at block 305, the user accesses his online banking account by using a web-based interface provided by his financial institution. Upon accessing the online banking account, the user may view all or any portion of the purchases that have been executed using the user's account. At block 310, the user identifies a purchase that he believes he did not make. For example, at block 310, the user may identify a purchase in the amount of $75.00 at Hardware Store Z that occurred on Jul. 27, 2012. The user may not remember making such a transaction and/or may believe that he did not make such a transaction. Accordingly, at block 315, the user initiates a payment dispute via his online banking account. Although not depicted in connection with FIG. 3, user's online banking account may also allow the user to provide additional information when initiating a dispute, such as user provided text or comments that could be used to help reconcile any dispute.

At block 320, the discrepancy apparatus receives transaction information associated with the user. In the embodiment of the invention represented by block 320, the discrepancy apparatus receives the location of Hardware Store Z. In this embodiment of the invention, the discrepancy apparatus receives the address of Hardware Store Z. Furthermore at block 320, the discrepancy apparatus also receives the date of the alleged purchase at Hardware Store Z (Jul. 27, 2012).

At block 325, the discrepancy apparatus compares the address of Hardware Store Z to locations where the user's mobile wallet made purchases. In this embodiment of the invention, the discrepancy apparatus accesses a list of GPS locations where the user's mobile computing device was located when it made mobile wallet purchases and the dates of such purchases. This list of GPS locations and dates may be stored located in the discrepancy apparatus or in the discrepancy apparatus may communicate with the user's mobile computing device (or any other remote storage device) to access this list of GPS locations. The discrepancy apparatus searches the list of GPS locations to see if any of the GPS locations correspond to address of Hardware Store Z. Additionally, to the extent there is a match between the GPS locations and the address of Hardware Store Z, the discrepancy apparatus also determines whether the mobile wallet purchase at the GPS location corresponding to Hardware Store Z was made on Jul. 27, 2012.

At block 330, the discrepancy apparatus determines whether there is a match between the locations/dates where the user used his mobile wallet to make purchases and the Jul. 27, 2012 purchase at Hardware Store Z. At block 335, if the discrepancy apparatus determines that there is not a match between the address of Hardware Store Z and the date of the purchase and the locations at which the user used his mobile wallet, then the discrepancy apparatus determines that there is a discrepancy associated with the user's account. Thus, the discrepancy sends an email to the user indicating that there is a discrepancy associated with the user's account. The discrepancy apparatus may send this email to an email address that is already on record with the user's financial institution or the discrepancy apparatus may prompt the user to input an email address.

The email that is sent at block 335 may be in any format. Additionally, the email may use any combination of words or symbols to indicate that there is a discrepancy associated with the user's account. In some embodiments, the email will indicate the alleged payment that is causing the discrepancy (e.g., the Jan. 12, 2012 payment at Hardware Store Z), and provide any other relevant information about the user's account (e.g., the status of the user's dispute request, etc). Further, in some embodiments, the email may include hyperlinks to allow the user to contact the user's financial institution (via phone, email, etc.) and/or submit additional information about the discrepancy.

At block 340, if the discrepancy apparatus determines that there is a match between the locations/dates where the user used his mobile wallet to make purchases and the Jul. 27, 2012 purchase at Hardware Store Z, then the discrepancy apparatus determines that there is not a discrepancy associated with the user's account and the discrepancy apparatus sends an email indicating that there is not a discrepancy associated with the user's account.

FIG. 4 provides a block diagram illustrating a system and environment 400 for electronic identification and notification of banking record discrepancies, in accordance with an embodiment of the invention. As illustrated in FIG. 4, the environment 400 includes a user 420 and a personal computing device 425 associated with user 420. The environment 400 also includes a discrepancy apparatus 430.

Personal computing device 425 and discrepancy apparatus 430 are each configured to communicate with each other over a network 410. The network 410 may include a local area network (LAN), a wide area network (WAN), a global area network (GAN), near field communication network, Bluetooth network or any other type of communications network or protocol. In some embodiments, network 410 may comprise the Internet. In addition, network 410 may include first, second, third, and/or fourth-generation cellular communication networks and/or the like. For example, the network 410 may include second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The network 410 may provide for wired, wireless, or a combination of wired and wireless communication between devices on the network.

The discrepancy apparatus 430 generally includes a processor 432 communicably coupled to such devices as a memory 436 and communication interface 434.

The processor 432 and other processors described herein may generally include circuitry for implementing communication and/or logic functions of the discrepancy apparatus 430. For example, the processor 430 may include a digital signal processor device, a microprocessor device, and various analog to digital converters, digital to analog converters, and/or other support circuits. Control and signal processing functions of the discrepancy apparatus 430 may be allocated between these devices according to their respective capabilities. The processor 432 thus may also include the functionality to encode and interleave messages and data prior to modulation and transmission. The processor 432 may additionally include an internal data modem. Further, the processor 432 may include functionality to operate one or more software programs or applications, which may be stored as computer-readable code in the memory 436.

The processor 432 may be configured to use the communication interface 434 to communicate with one or more other devices on a network. The processor 432 may be configured to provide signals to and receive signals from the communication interface 434. In some embodiments, the signals may include signaling information in accordance with the air interface standard of the applicable cellular system of the wireless telephone network that may be part of the network. In this regard, the discrepancy apparatus 430 may be configured to operate with one or more air interface standards, communication protocols, modulation types, and access types. For example, the discrepancy apparatus 430 may be configured to operate in accordance with second-generation (2G) wireless communication protocols, third-generation (3G) wireless communication protocols, fourth-generation (4G) wireless communication protocols, and/or the like. The discrepancy apparatus 430 may also be configured to operate in accordance with non-cellular communication mechanisms, such as via a wireless local area network (WLAN), global area network (GAN), a wide-area network (WAN), the Internet, and/or other communication/data networks.

As further illustrated in FIG. 4, the discrepancy apparatus 430 includes memory 436. In some embodiments, the memory 436 contains discrepancy application 438 and bank records 440. Discrepancy application 438 includes computer code that, when executed by the processor 432, performs one or more of the functions described herein in relation to the discrepancy apparatus 430. In some embodiments, discrepancy application 438 is configured to perform the process described in relation to blocks 110 to 130 of FIG. 1. The memory 436 also includes data stored therein, such as bank records 440. Bank records 440 may comprise online banking information, mobile wallet information or any other data or information associated with the user's accounts. In some embodiments, discrepancy apparatus 430 may be maintained and stored by a financial institution, bank, third-party service provider, and/or any other entity that wishes to provide the functionality described herein. In other embodiments, discrepancy apparatus 430 or portions thereof may be incorporated into personal computing device 425.

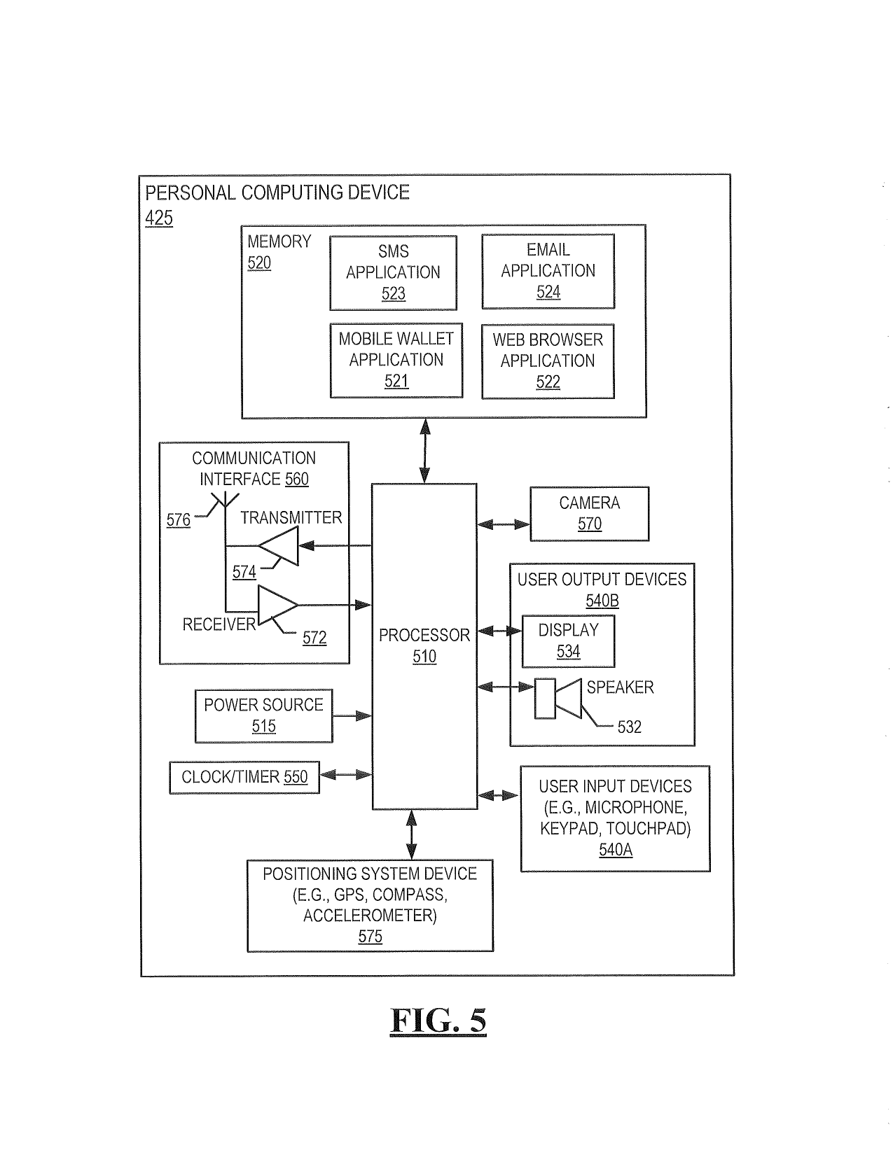

Personal computer device 425 may comprise any type of personal computing device. Although not depicted in FIG. 4, personal computing device 425 will generally comprise a processor, communication interface, and memory. The processor described in connection with personal computing device 425 may generally include circuitry for implementing communication and/or logic functions of personal computing device 425. The processor may be configured to use the communication interface to communicate with one or more other devices on a network. The processor may be configured to provide signals to and receive signals from the communication interface. Additionally, the personal computing device 425 includes memory. In some embodiments, the memory contains one or more applications having computer code that, when executed by the processor of personal computing device 425, performs one or more of the functions described herein in relation to personal computing device 425. An embodiment of personal computing device 425 will be described in greater detail in connection with FIG. 5.

FIG. 5 depicts a detailed illustration of personal computing device 425, in accordance with an embodiment of the present invention. In this embodiment, personal computing device 425 is a mobile computing device (e.g., mobile phone, pda, etc.). As depicted in FIG. 5, personal computing device 425 may generally include a processor 510 communicably coupled to such devices as a memory 520, user output devices 540B, user input devices 540A, a communication interface 560, a power source 515, a clock or other timer 550, and positioning system device 575.

As depicted in FIG. 5, the processor 510 may be configured to use the communication interface 560 to communicate with one or more other devices on a network. In this regard, the communication interface 560 may include an antenna 576 operatively coupled to a transmitter 574 and a receiver 572 (together a “transceiver”). The processor 510 may be configured to provide signals to and receive signals from the transmitter 574 and the receiver 572, respectively. The signals may include signaling information in accordance with the air interface standard of the applicable cellular system of the wireless telephone network that may be part of the network. In this regard, the personal computing device 425 may be configured to operate with one or more air interface standards, communication protocols, modulation types, and access types. In some embodiments, personal computing device 425 may be configured to operate in accordance with second-generation (2G) wireless communication protocols, third-generation (3G) wireless communication protocols, and/or fourth-generation (4G) wireless communication protocols, and/or the like. The personal computing device 425 may also be configured to operate in accordance with non-cellular communication mechanisms, such as via a WLAN, WAN, GAN, the Internet and/or other communication/data networks.

As described above, the personal computing device 425 may have a user interface 540 that includes user output devices 540B and/or user input devices 540A. The user output devices 540B may include a display 534 (e.g., a liquid crystal display (LCD) or the like) and a speaker 532 or other audio device, which are operatively coupled to the processor 510. The user input devices 540A, which may allow the personal computing device 425 to receive data from the user 420, may include any of a number of devices allowing the mobile computing device 312 to receive data from a user, such as a keypad, keyboard, touch-screen, touchpad, microphone, mouse, joystick, other pointer device, button, soft key, and/or other input device(s).

The personal computing device 425 may further include a power source 515. Generally, the power source 515 is a device that supplies electrical energy to an electrical load. In one embodiment, the power source 515 may convert a form of energy such as solar energy, chemical energy, mechanical energy, etc. to electrical energy. Generally, the power source 515 in the personal computing device 425 may be a battery, such as a lithium battery, a nickel-metal hydride battery, or the like, that is used for powering various circuits, e.g., the transceiver circuit, and other devices that are used to operate the personal computing device 425. Alternatively, the power source 515 may be a power adapter that can connect a power supply from a power outlet to the personal computing device 425. In such embodiments, a power adapter may be classified as a power source “in” the mobile computing device.

The personal computing device 425 may also include a memory 520 operatively coupled to the processor 510. As used herein, memory may include any computer readable medium configured to store data, code, or other information. The memory 520 may include volatile memory, such as volatile Random Access Memory (RAM) including a cache area for the temporary storage of data. The memory 520 may also include non-volatile memory, which can be embedded and/or may be removable. The non-volatile memory may additionally or alternatively include an electrically erasable programmable read-only memory (EEPROM), flash memory or the like.

The memory 520 may store any of a number of applications or programs which include computer-executable instructions/code executed by the processor 510 to implement the functions of the personal computing device 425 described herein. For example, the memory 520 may include such applications as a mobile wallet application 521, a web browser application 522, an SMS application 523, an email application 524, etc. Although not depicted in FIG. 5, in other embodiments of the invention, the memory 520 may store all or part of discrepancy application 438 and/or bank records 440.

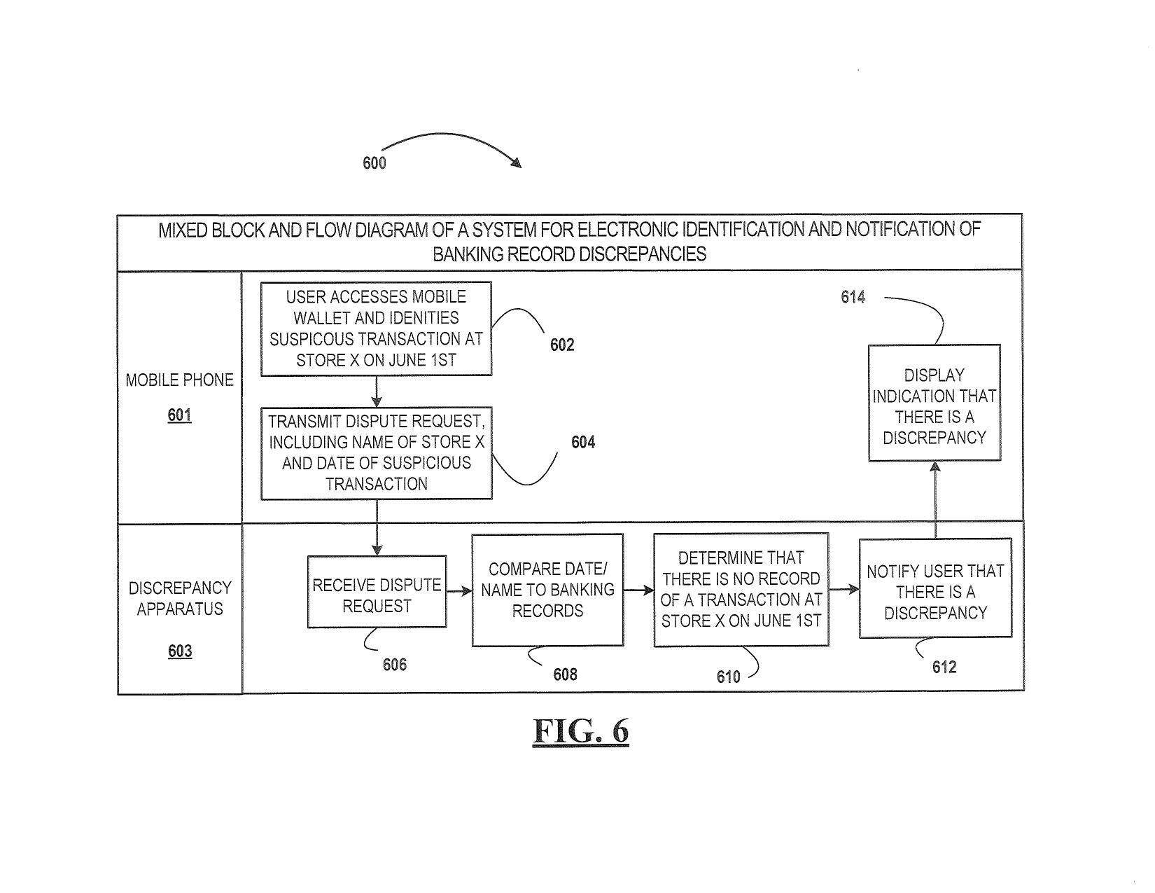

Referring now to FIG. 6, a mixed block and flow diagram of a system 600 is provided for the electronic identification and notification of banking record discrepancies. It will be understood that the system 600 illustrated in FIG. 6 represents an embodiment of the process flow 100 described in connection with FIG. 1. In general terms, FIG. 6 illustrates an embodiment of the method of the present invention. In this embodiment, a user (“User”) receives a notification that there is a discrepancy between the information contained in his mobile wallet and his banking records. Mobile phone 601 is an embodiment of personal computing device 425, as is depicted in FIG. 5. Discrepancy apparatus 603 is an embodiment of discrepancy apparatus 430, as depicted in FIG. 4.

As depicted at block 602, User accesses the mobile wallet, via mobile phone 601, and identifies a suspicious transaction at Store X, which allegedly occurred on June 1st. In accessing the mobile wallet, User is able to view a list of all mobile wallet transactions. With regards to the June 1st transaction at Store X, User may not remember making that transaction or may otherwise believe that he did not make that transaction. As such, the transaction is suspicious because it is listed as being attributed to User's mobile wallet.

At block 604, User transmits a dispute request relating to the June 1st transaction at Store X. In this embodiment, User transmits this request to discrepancy apparatus 603 using the functionality of mobile phone 601. For example, after accessing his mobile wallet, User could use the functionality of mobile phone 601 to indicate that he would like to transmit a dispute request for the June 1st transaction. As one of skill in the art will appreciate, User could make this indication using any number of methods, including, using the display of mobile phone 601, voice commands, physical gestures, etc. The dispute request which is transmitted to discrepancy apparatus 603 includes the name of Store X and the date of the transaction. As one of skill in the art will appreciate, the dispute request may require the transmission of any additional information that may be relevant to the suspicious transaction.

Although not depicted in connection with 604, the user's mobile wallet may also allow the user to provide additional information when initiating a dispute, such as user provided text or comments that could be used to help reconcile any dispute.

At block 604, the mobile phone 601 transmits the dispute request via a cellular communications network. However, as discussed in connection with FIG. 4, in other embodiments of the invention, the mobile phone 601 and discrepancy apparatus 603 may communicate over any other type of communications network. At block 606, the discrepancy apparatus 606 receives the dispute request from mobile phone 601.

At block 608, discrepancy apparatus 603 compares the name and date of the suspicious transaction (e.g., Store X, June 1st) to the user's banking records to determine whether the banking records have an entry for a June 1st purchase at Store X. The banking records may be stored in a memory device of the discrepancy apparatus 603 or they may be stored in the memory device of another device that communicably connected to discrepancy apparatus 603. At block 608, the discrepancy apparatus uses data comparison techniques that would be known to one of skill in the art to determine whether there is a match between the name and date of the suspicious transaction and the user's banking records.

At block 610, the discrepancy apparatus 603 determines that the user's banking records contain no record of a transaction at Store X on June 1st. Accordingly, at block 612 the discrepancy apparatus 603 notifies the User that there is a discrepancy associated with the user's account. As indicated at block 614, the discrepancy apparatus notifies the User by displaying an indication on the display of mobile phone 601. Transaction apparatus 603 notifies the mobile phone 601 by communicating over a cellular network. However, in other embodiments of the invention, the discrepancy apparatus 603 may communicate with mobile phone 601 using any other type of communications network.

At block 614, the indication that is displayed on mobile phone 601 may be any type of indication. In the embodiment of the invention depicted at block 614, the indication appears as a pop up window on the display of mobile phone 601 notifies the User that there is a discrepancy associated with the user's account. The pop-up window indicates the name of the suspicious transaction (e.g., June 1st transaction at Store X) and also contains hyperlinks to allow the User to contact his financial institution, as well as submit additional information about the suspicious transaction. Lastly, the pop-up window indicates the current status of the User's dispute request, such as “request received”, “investigation in progress”, or “investigation concluded”.

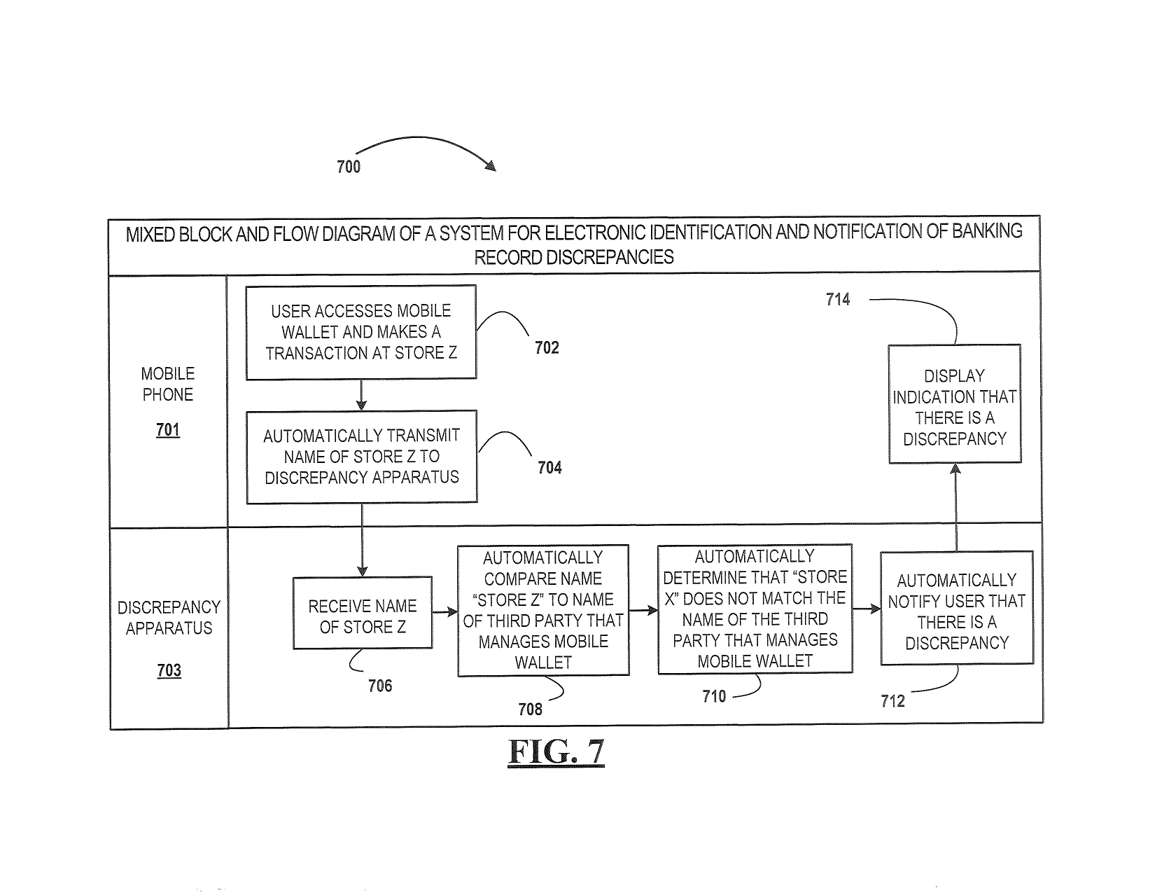

Referring now to FIG. 7, a mixed block and flow diagram of a system 700 is provided for the electronic identification and notification of banking record discrepancies. It will be understood that the system 700 illustrated in FIG. 7 represents an embodiment of the process flow 100 described in connection with FIG. 1. In general terms, FIG. 7 illustrates an embodiment of the method of the present invention. In this embodiment, a user (“User”) receives a notification that there is a discrepancy between the information contained in his mobile wallet and his banking records. Mobile phone 701 is an embodiment of personal computing device 425, as is depicted in FIG. 5. Discrepancy apparatus 703 is an embodiment of discrepancy apparatus 430, as depicted in FIG. 4.

FIG. 7 also illustrates an embodiment of the method of the present invention in which a third party manages the user's mobile wallet functionality. In this embodiment, such third party serves as the merchant of record for all transactions made using the mobile wallet functionality (as opposed to the name of the actual merchant that conducted the transaction).

As depicted at block 702, User accesses the mobile wallet, via mobile phone 701, to make a transaction at Store Z. At block 704, mobile device 701 automatically transmits the name “Store Z” to discrepancy apparatus 703. At block 704, the mobile phone 701 transmits the name “Store Z” via a cellular communications network. However, as discussed in connection with FIG. 4, in other embodiments of the invention, the mobile phone 701 and discrepancy apparatus 703 may communicate over any other type of communications network. At block 706, the discrepancy apparatus 703 receives the name “Store Z” from mobile phone 701.

At block 708, discrepancy apparatus 703 automatically compares the name “Store Z” to the name of the third party that manages the user's mobile wallet. Since the name of the third party that manages the user's mobile wallet is the merchant of record, such name is stored in the user's banking records. The banking records may be stored in a memory device of the discrepancy apparatus 703 or they may be stored in the memory device of another device that communicably connected to discrepancy apparatus 703. At block 708, the discrepancy apparatus uses text comparison techniques that would be known to one of skill in the art to determine whether there is a match between the name and date of the suspicious transaction and the user's banking records.

At block 710, the discrepancy apparatus 703 automatically determines that name “Store X” does not match the name of the third party that manages the user's mobile wallet. Accordingly, at block 712 the discrepancy apparatus 703 notifies the User that there is a discrepancy with the user's banking records. As indicated at block 714, the discrepancy apparatus notifies the User by displaying an indication on the display of mobile phone 701. Transaction apparatus 703 notifies the mobile phone 701 by communicating over a cellular network. However, in other embodiments of the invention, the discrepancy apparatus 703 may communicate with mobile phone 701 using any other type of communications network.

At block 714, the indication that is displayed on mobile phone 701 may be any type of indication. In the embodiment of the invention depicted at block 714, the indication appears as a pop up window on the display of mobile phone 701 notifies the User that there is a discrepancy with the user's banking records. The pop-up window indicates the names of “Store X” and the third party that manages the user's mobile wallet and also contains hyperlinks to allow the User to contact his financial institution, as well as submit additional information to help reconcile the discrepancy.

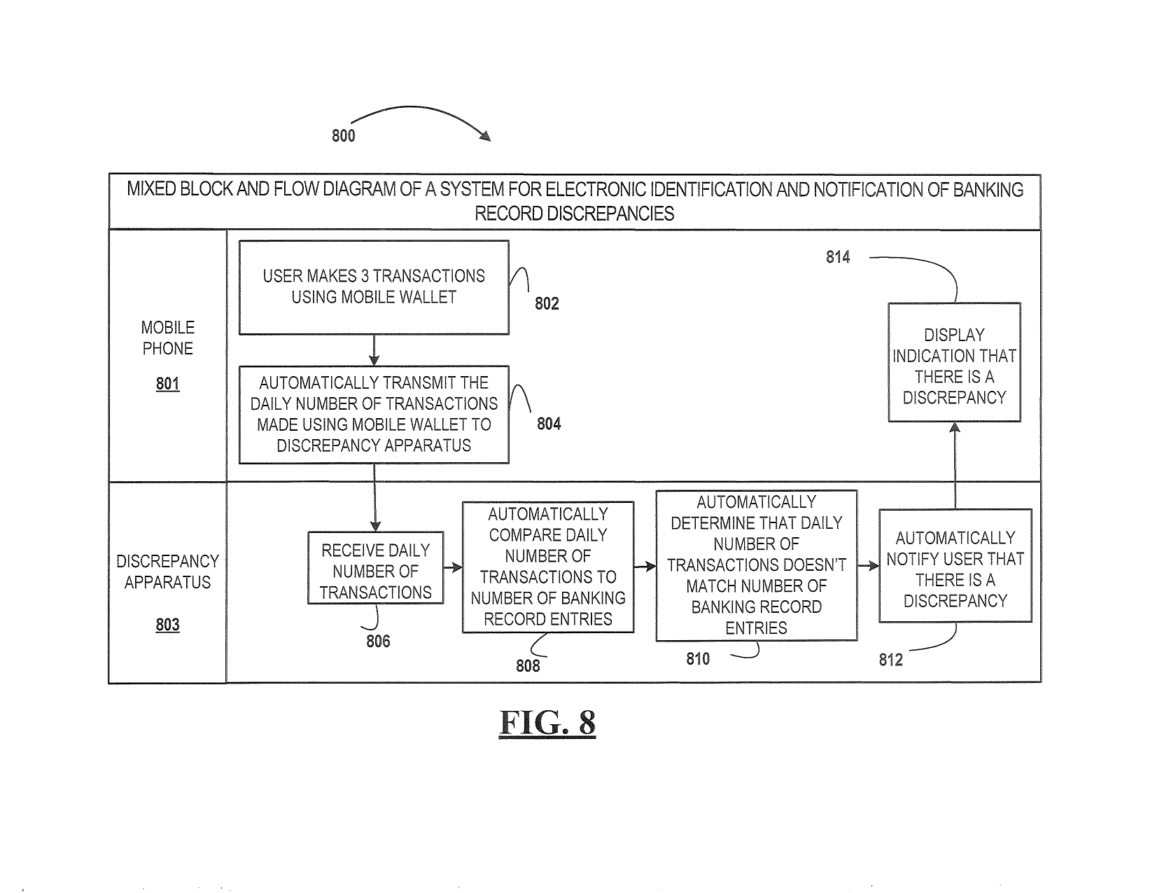

Referring now to FIG. 8, a mixed block and flow diagram of a system 800 is provided for the electronic identification and notification of banking record discrepancies. It will be understood that the system 800 illustrated in FIG. 8 represents an embodiment of the process flow 100 described in connection with FIG. 1. In general terms, FIG. 8 illustrates an embodiment of the method of the present invention. In this embodiment, a user (“User”) receives a notification that there is a discrepancy between the information contained in his mobile wallet and his banking records. Mobile phone 801 is an embodiment of personal computing device 425, as is depicted in FIG. 5. Discrepancy apparatus 803 is an embodiment of discrepancy apparatus 430, as depicted in FIG. 4.

FIG. 8 also illustrates an embodiment of the method of the present invention in which a third party manages the user's mobile wallet functionality. In this embodiment, such third party aggregates all of the daily mobile wallet purchases and reports such purchases to the user's financial institution as one aggregate, daily transaction, in which such third party is the merchant of record.

As depicted at block 802, User makes three transactions using the mobile wallet. At block 804, mobile device 801 automatically transmits this number of transactions made using the mobile wallet (the “daily number of transactions”). At block 804, the mobile phone 801 transmits the daily number of transactions via a cellular communications network. However, as discussed in connection with FIG. 4, in other embodiments of the invention, the mobile phone 801 and discrepancy apparatus 803 may communicate over any other type of communications network. At block 806, the discrepancy apparatus 803 receives the daily number of transactions from mobile phone 801.

At block 808, discrepancy apparatus 803 automatically compares the daily number of transactions to the number of banking record entries. The banking records may be stored in a memory device of the discrepancy apparatus 803 or they may be stored in the memory device of another device that communicably connected to discrepancy apparatus 803. At block 808, the discrepancy apparatus uses data comparison techniques that would be known to one of skill in the art to determine whether there is a match between the daily number of transactions and the number of banking record entries.

Since the third party that manages the user's mobile wallet aggregates all of the daily mobile wallet purchases and reports such purchases to the user's financial institution as one aggregate, daily transaction, at block 810 the transaction apparatus automatically determines that there is not a match between the daily number of transaction and the number of banking record entries. Accordingly, at block 812 the discrepancy apparatus 803 notifies the User that there is a discrepancy with the user's banking records. As indicated at block 814, the discrepancy apparatus notifies the User by displaying an indication on the display of mobile phone 801. Transaction apparatus 803 notifies the mobile phone 801 by communicating over a cellular network. However, in other embodiments of the invention, the discrepancy apparatus 803 may communicate with mobile phone 801 using any other type of communications network.

At block 814, the indication that is displayed on mobile phone 801 may be any type of indication. In the embodiment of the invention depicted at block 814, the indication appears as a pop up window on the display of mobile phone 801 notifies the User that there is a discrepancy with the user's banking records. The pop-up window indicates that the daily number of transactions differs from the number of banking record entries and also contains hyperlinks to allow the User to contact his financial institution, as well as submit additional information to help reconcile the discrepancy.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s)

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

1. An apparatus for determining whether there is a discrepancy associated with a user's account, the apparatus comprising:
a communication device,
a processing device communicable coupled to the communication device; and
a non-transitory computer-readable storage medium comprising computer-executable instructions for causing the processing device to:
receive mobile wallet information from a mobile computing device of the user, wherein the mobile computing device features mobile wallet functionality;
compare the mobile wallet information to bank records of the user to determine whether the mobile wallet information and the bank records list the same number of transactions and whether the mobile wallet information and the bank records list transactions with the same third parties;
determine, based at least partially on the mobile wallet information, whether there is a discrepancy associated with the user's account; and
present an indication of whether there is a discrepancy associated with the user's account.

2. The apparatus of claim 1, wherein the discrepancy associated with the user's account comprises an unauthorized transaction.

3. The apparatus of claim 1, wherein the discrepancy associated with the user's account is caused by the entity providing the mobile wallet functionality.

4. (canceled)

5. The apparatus of claim 1, wherein the non-transitory computer-readable storage medium comprises computer-executable instructions for causing the processing device to compare the mobile wallet information to the bank records to determine whether the mobile wallet information and the bank records list purchases having the same values.

6. (canceled)

7. The apparatus of claim 1, wherein the indication comprises an indication that appears on the display of a mobile computing device of the user.

8. The apparatus of claim 1, wherein the non-transitory computer-readable storage medium comprises computer-executable instructions for causing the processing device to automatically receive mobile wallet information from the mobile computing device of the user.

9. The apparatus of claim 1, wherein the non-transitory computer-readable storage medium comprises computer-executable instructions for causing the processing device to only receive mobile wallet information from the mobile computing device of the user upon the action of the user.

10. A computer implemented method for determining whether there is a discrepancy associated with a user's account, the computer implemented method comprising:
receiving, with a processing device, mobile wallet information from a mobile computing device of the user, wherein the mobile computing device features mobile wallet functionality;
comparing, with a processing device, the mobile wallet information to bank records of the user to determine whether the mobile wallet information and the bank records list the same number of transactions and whether the mobile wallet information and the bank records list transactions with the same third parties;
determining with a processing device, based at least partially on the mobile wallet information, whether there is a discrepancy associated with the user's account; and
presenting, with a processing device, an indication of whether there is a discrepancy associated with the user's account.

11. The method of claim 10, wherein determining whether there is a discrepancy associated with user's account comprises whether determining whether there is an unauthorized transaction associated with the user's account.

12. The method of claim 10, wherein determining whether there is a discrepancy associated with user's account comprises whether determining whether the discrepancy was caused by the entity providing the mobile wallet functionality.

13. (canceled)

14. The method of claim 10, wherein comparing the mobile wallet information to the bank records comprises determining whether the mobile wallet information and the bank records list purchases having the same values.

15. (canceled)

16. The method of claim 10, wherein presenting an indication comprises presenting an indication that appears on the display of a mobile computing device of the user.

17. The method of claim 10, wherein receiving mobile wallet information from a mobile computing device of the user the processing device comprises automatically receiving mobile wallet information from the mobile computing device of the user.

18. The method of claim 10, wherein receiving mobile wallet information from a mobile computing device of the user comprises receiving mobile wallet information from the mobile computing device of the user upon the action of the user.

19. A computer program product for determining discrepancies associated with a user's account, the computer program product comprising a non-transitory computer-readable medium, wherein the non-transitory computer-readable medium comprises computer executable program code store therein, the computer executable program code comprising:
a first executable portion configured for receiving mobile wallet information from a mobile computing device of the user, wherein the mobile computing device features mobile wallet functionality;
a second executable portion configured for comparing the mobile wallet information to bank records of the user to determine whether the mobile wallet information and the bank records list the same number of transactions and whether the mobile wallet information and the bank records list transactions with the same third parties;
a third executable portion configured for determining, based at least partially on the mobile wallet information, whether there is a discrepancy associated with the user's account; and
a fourth executable portion configured for presenting an indication of whether there is a discrepancy associated with the user's account.

20. The computer program product of claim 19, wherein determining whether there is a discrepancy associated with user's account comprises whether determining whether there is an unauthorized transaction associated with the user's account.

21. The computer program product of claim 19, wherein determining whether there is a discrepancy associated with user's account comprises whether determining whether the discrepancy was caused by the entity providing the mobile wallet functionality.

22. (canceled)

23. The computer program product of claim 19, wherein comparing the mobile wallet information to the bank records comprises determining whether the mobile wallet information and the bank records list purchases having the same values.

24. (canceled)

25. The computer program product of claim 19, wherein presenting an indication comprises presenting an indication that appears on the display of a mobile computing device of the user.

26. The computer program product of claim 19, wherein receiving mobile wallet information from a mobile computing device of the user the processing device comprises automatically receiving mobile wallet information from the mobile computing device of the user.

27. The computer program product of claim 19, wherein receiving mobile wallet information from a mobile computing device of the user comprises receiving mobile wallet information from the mobile computing device of the user upon the action of the user.

28. The computer program product of claim 27, wherein receiving mobile wallet information from the mobile computing device of the user comprises receiving a payment dispute from the user.

29. The computer program product of claim 19, wherein:
receiving mobile wallet information from the mobile computing device of the user comprises receiving location history information of the mobile computing device of the user;
comparing the mobile wallet information to bank records of the user comprises comparing the location history information of the mobile computing device of the user and location information of a merchant associated with a first transaction to determine whether the location of mobile computing device of the user matched the location of the merchant associated with the first transaction at the time of the first transaction; and
determining whether there is a discrepancy associated with the user's account is based at least partially on whether the location of mobile computing device of the user matched the location of the merchant associated with the first transaction at the time of the first transaction.

30. The apparatus of claim 9, wherein the non-transitory computer-readable storage medium comprises computer-executable instructions for causing the processing device to receive a payment dispute from the user before receiving mobile wallet information from the mobile computing device of the user.

31. The apparatus of claim 1, wherein the non-transitory computer-readable storage medium comprises computer-executable instructions for causing the processing device to:
receive location history information of the mobile computing device of the user;
receive location information of a merchant associated with a first transaction;
compare the location history information of the mobile computing device of the user and the location information of the merchant associated with the first transaction to determine whether the location of mobile computing device of the user matched the location of the merchant associated with the first transaction at the time of the first transaction; and
determine, based at least partially on whether the location of mobile computing device of the user matched the location of the merchant associated with the first transaction at the time of the first transaction, whether there is a discrepancy associated with the user's account.

32. The method of claim 19, comprising receiving a payment dispute from the user before receiving mobile wallet information from the mobile computing device of the user.

33. The method of claim 10, comprising:
receiving location history information of the mobile computing device of the user;
receiving location information of a merchant associated with a first transaction;
comparing the location history information of the mobile computing device of the user and the location information of the merchant associated with the first transaction to determine whether the location of mobile computing device of the user matched the location of the merchant associated with the first transaction at the time of the first transaction; and
determining, based at least partially on whether the location of mobile computing device of the user matched the location of the merchant associated with the first transaction at the time of the first transaction, whether there is a discrepancy associated with the user's account.
